(19) United States
(12) Patent Application Publication
(10) Pub. No.: US 2026/0193902 A1
(43) Pub. Date: Jul. 9, 2026

(54) SILENT LOCK

(71) Applicant: LOCKIN TECHNOLOGY (BEIJING) CO., LTD., Beijing (CN)

(72) Inventors: Fulonghui LIU, Beijing (CN); Bin CHEN, Beijing (CN)

(73) Assignee: LOCKIN TECHNOLOGY (BEIJING) CO., LTD., Beijing (CN)

(21) Appl. No.: 19/129,859

(22) PCT Filed: Sep. 19, 2023
(86) PCT No.: PCT/CN2023/119637

§ 371 Date: May 14, 2025

(30) Foreign Application Priority Data
Nov. 16, 2022 (CN) 202211434635.3

(51) Int. Cl. E05B 17/00; E05B 15/04; E05B 15/10; E05B 59/00

(52) U.S. Cl. CPC E05B 17/0045; E05B 15/101; E05B 15/108; E05B 59/00; E05B 2015/0406

(57) ABSTRACT

A silent lock, comprising a lock shell, a latch bolt, a first elastic member and a second elastic member. The latch bolt is slidably connected to the lock shell, the latch bolt has a first retracted position located inside the lock shell and a first extended position at least partially protruding out of the lock shell, and the first elastic member connects the latch bolt and the lock shell and presses the latch bolt toward the first extended position; the second elastic member connects the latch bolt and the lock shell and presses the latch bolt toward the first retracted position; and when the latch bolt (2) is in the first extended position, the elastic force of the first elastic member is equal to the elastic force of the second elastic member.

The present application claims the priority to Chinese Patent Application No. 202211434635.3, titled “SILENT LOCK”, filed with the China National Intellectual Property Administration on Nov. 16, 2022, the entire content of which is incorporated herein by reference.

### FIELD

The present application relates to the technical field of door locks, and in particular to a silent lock.

### BACKGROUND

When the door is opened and closed, the sound caused from the lock body itself and the impact between the bolt and the door frame significantly disturb the resident's rest and degrade user's experience.

In the related technology, a method of using magnetic attraction for the door lock to achieve noise reduction and silence has low safety and is generally only applicable to an inner door lock. Another method of using plastic on side strips for noise reduction and silence increases the complexity of processing and assembling and reduces the aesthetic appearance of the side strips.

### SUMMARY

The present application aims to solve at least one of the technical problems in the related technology to a certain extent. In view of this, a silent lock is provided according to an embodiment of the present application, which has advantages of a broad application range, a highly aesthetic appearance of side strips thereof, and avoidance of complex processing and assembly operations.

The silent lock according to an embodiment of the present application includes a lock shell, a latch bolt, a first elastic member and a second elastic member. The latch bolt is slidably connected to the lock shell, and the latch bolt is movable between a first retracted position where it is located inside the lock shell and a first extended position where it at least partially protrudes out of the lock shell. The first elastic member is connected to the latch bolt and the lock shell and biases the latch bolt toward the first extended position, and the second elastic member is connected to the latch bolt and the lock shell and biases the latch bolt toward the first retracted position. When the latch bolt is in the first extended position, an elastic force of the first elastic member is equal to that of the second elastic member.

According to the silent lock in this embodiment of the present application, the silent lock in this embodiment is not constrained by mounting environments, granting it a broader application range. Furthermore, the silent lock in this embodiment eliminates the need for modifying the side strips, which ensures the aesthetic appearance of the side strips, and avoids complex processing and assembly operations.

In some embodiments, the silent lock further includes a first guide shaft, a first baffle and a movable plate. A first end of the first guide shaft is connected to the latch bolt. The first baffle is fixedly arranged inside the lock shell and is provided with a first hole, through which the first guide shaft slides. The first elastic member includes a first spring arranged around the first guide shaft, and the first spring is pressed between the latch bolt and the first baffle. The movable plate is located at a side of the first baffle facing away from the latch bolt and is connected to a second end of the first guide shaft. The second elastic member includes a second spring arranged around the first guide shaft, and the second spring is pressed between the first baffle and the movable plate.

In some embodiments, the silent lock further includes a detection tongue, a third elastic member and a push sheet. The detection tongue is slidably fitted inside the lock shell. The detection tongue is movable between a second retracted position where it is located inside the lock shell and a second extended position where it at least partially protrudes out of the lock shell, and a direction in which the detection tongue slides toward the second retracted position is consistent with a direction in which the latch bolt slides toward the first retracted position. The third elastic member is connected to the detection tongue and the lock shell, and biases the detection tongue toward the second extended position. The push sheet is located inside the lock shell and is connected to the detection tongue. The latch bolt has a limiting surface facing the first baffle, and at least part of the push sheet abuts against the limiting surface.

In some embodiments, the silent lock further includes a second guide shaft and a second baffle. A first end of the second guide shaft is connected to the detection tongue. The second baffle is fixedly arranged inside the lock shell, and is provided with a second hole, through which the second guide shaft slides. The third elastic member includes a third spring arranged around the second guide shaft, and the third spring is pressed between the second baffle and the detection tongue.

In some embodiments, the silent lock further includes a dead bolt assembly and a first buffer member. The dead bolt assembly is slidably connected to the lock shell. The dead bolt assembly is movable between a third retracted position where it is located inside the lock shell and a third extended position where it at least partially protrudes out of the lock shell. The first buffer member is fixedly arranged inside the lock shell, and the dead bolt assembly abuts against the first buffer member when it is in the third retracted position.

In some embodiments, the dead bolt assembly includes multiple dead bolts and a connecting frame. The multiple dead bolts are arranged and spaced apart from each other in a length direction of the lock shell, and each of the multiple dead bolts is slidably connected to the lock shell. The connecting frame is located inside the lock shell, and has a first end connected to each of the dead bolts and has a second end abutting against the first buffer member when the dead bolt assembly is in the third retracted position.

In some embodiments, the silent lock includes a second buffer member, which is disposed inside the lock shell and is fixedly arranged between any two adjacent dead bolts. When the dead bolt assembly is in the third extended position, the second buffer member is sandwiched between a peripheral wall of the lock shell and the connecting frame.

In some embodiments, the first buffer member includes a support shaft and a flexible sleeve. The support shaft is fixedly arranged inside the lock shell, the flexible sleeve is arranged around the support shaft, and the second end of the connecting frame abuts against the flexible sleeve when the dead bolt assembly is in the third retracted position. The second buffer member includes a flexible block.

In some embodiments, the silent lock further includes a pin and an anti-release hook. The latch bolt has a mounting groove and a first shaft hole. The first shaft hole extends in a length direction of the lock shell and is in communication with the mounting groove, and the pin is connected to the latch bolt by passing through the first shaft hole and the mounting groove. The anti-release hook is provided with a second shaft hole. The anti-release hook is arranged around the pin by inserting the pin through the second shaft hole and is fitted in the mounting groove in such a manner as to be pivoted relative to the pin.

In some embodiments, damping agent is filled between a wall surface of the second shaft hole and an outer circumferential surface of the pin, or damping coating is provided on an outer circumferential surface of the pin.

### BRIEF DESCRIPTION OF THE DRAWINGS

FIG. 1 is a schematic view of a silent lock according to an embodiment of the present application.

FIG. 2 is a schematic view of a latch bolt portion of a silent lock according to an embodiment of the present application.

FIG. 3 is a schematic view of a detection tongue portion of a silent lock according to an embodiment of the present application.

### REFERENCE NUMERALS ARE EXPLAINED AS FOLLOWS

| | |
|---|---|
| 1 lock shell, | 2 latch bolt, |
| 21 first elastic member, | 211 first spring, |
| 22 second elastic member, | 221 second spring, |
| 23 first guide shaft, | 24 first baffle, |
| 25 movable plate, | 26 limiting surface, |
| 27 mounting groove, | 28 first shaft hole, |
| 3 detection tongue, | 31 third elastic member, |
| 311 third spring, | 32 push sheet, |
| 33 second guide shaft, | 4 dead bolt assembly, |
| 41 first buffer member, | 411 support shaft, |
| 412 flexible sleeve, | 42 dead bolt, |
| 43 connecting frame, | 44 second buffer member, |
| 441 flexible block, | 5 pin, |
| 6 anti-release hook. | 61 second shaft hole. |

### DETAILED DESCRIPTION OF THE EMBODIMENTS

The embodiments of the present application will be described in detail below, and examples of which are shown in the accompanying drawings. The embodiments described below with reference to the accompanying drawings are exemplary and are intended to explain the present application, but should not be construed as limiting the present application.

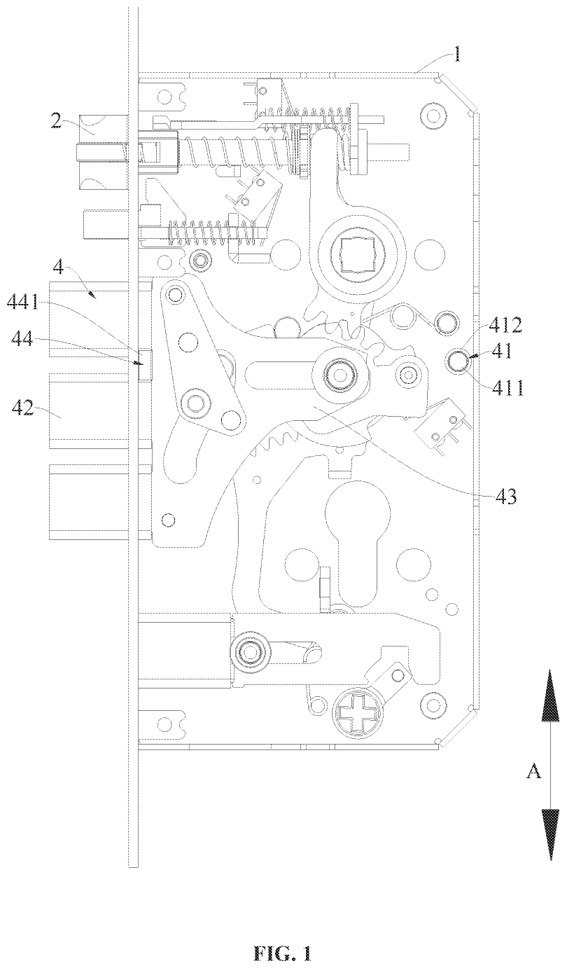

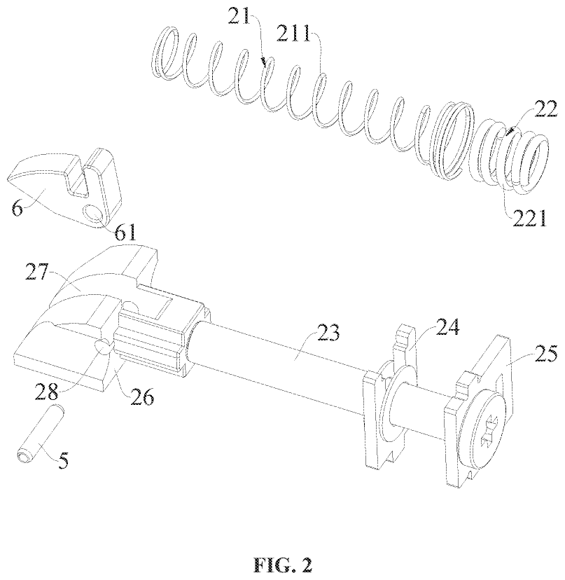

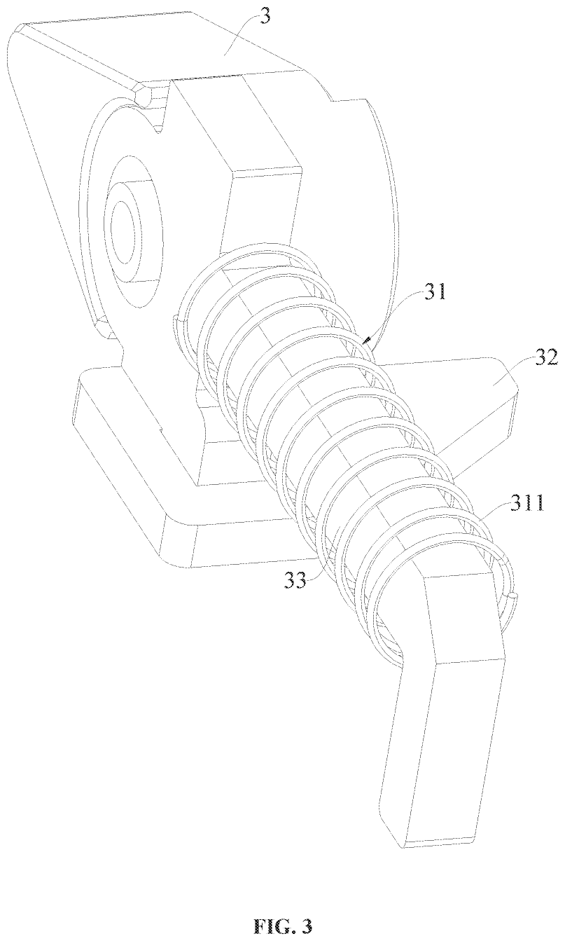

A silent lock according to an embodiment of the present application is described below with reference to FIG. 1 to FIG. 3.

The silent lock according to an embodiment of the present application includes a lock shell 1, a latch bolt 2, a first elastic member 21 and a second elastic member 22. The latch bolt 2 is slidably connected to the lock shell 1, and the latch bolt 2 is movable between a first retracted position where it is located inside the lock shell 1 and a first extended position where it at least partially protrudes out of the lock shell 1. The first elastic member 21 is connected to the latch bolt 2 and the lock shell 1 and biases the latch bolt 2 toward the first extended position. The second elastic member 22 is connected to the latch bolt 2 and the lock shell 1 and biases the latch bolt 2 toward the first retracted position. When the latch bolt 2 is in the first extended position, an elastic force of the first elastic member 21 is equal to that of the second elastic member 22.

For the silent lock according to the embodiment of the present application, during locking or unlocking of the silent lock, the latch bolt 2 is pressed by an external force and moved from the first extended position to the first retracted position, causing disrupted equilibrium between the elastic force of the first elastic member 21 and the elastic force of the second elastic member 22. Upon the external force is released, the latch bolt 2 is reset under a resultant force of the first elastic member 21 and the second elastic member 22. When the latch bolt 2 is reset to the first extended position, the first elastic member 21 and the second elastic member 22 serve to cushion and dampen the movement of the latch bolt 2, and assist the latch bolt 2 to reciprocate near the first extended position until the kinetic energy of the latch bolt 2 is dissipated, at which point the latch bolt 2 comes to rest at the first extended position.

In this way, the impact force exerted on the latch bolt 2 during its reset is reduced by the first elastic member 21 and the second elastic member 22, which avoids mechanical collision and severe friction between the latch bolt 2 and a mechanical component (such as a door latch when locking), thereby reducing noise generated during the locking and unlocking of the lock and achieving the effect of silencing.

In addition, the silent lock in this embodiment is not constrained by mounting environments, granting it a broader application range. Furthermore, the silent lock in this embodiment eliminates the need for modifying side strips, which ensures the aesthetic appearance of the side strips, and avoids complex processing and assembly operations.

It can be understood that the force applied on the latch bolt 2 by the first elastic member 21 and the force applied on the latch bolt 2 by the second elastic member 22 are in equilibrium when the latch bolt 2 is in the first extending position.

In some embodiments, the silent lock further includes a first guide shaft 23, a first baffle 24 and a movable plate 25. A first end of the first guide shaft 23 is connected to the latch bolt 2. The first baffle 24 is fixedly arranged inside the lock shell 1 and is provided with a first hole, through which the first guide shaft 23 slides. The first elastic member 21 includes a first spring 211 arranged around the first guide shaft 23, and the first spring 211 is pressed between the latch bolt 2 and the first baffle 24. The movable plate 25 is located at a side of the first baffle 24 facing away from the latch bolt 2 and is connected to a second end of the first guide shaft 23. The second elastic member 22 includes a second spring 221 arranged around the first guide shaft 23, and the second spring 221 is pressed between the first baffle 24 and the movable plate 25.

Therefore, the cooperation between the first guide shaft 23 and the first hole restricts a sliding direction of the latch bolt 2, and ensures the reliability of the latch bolt 2 sliding between the first extended position and the first retracted position. During the resetting of the latch bolt 2, the first spring 211 and the second spring 221 provide damping and cushioning effects for the latch bolt 2, thereby ensuring the stability of the latch bolt 2 sliding between the first extended position and the first retracted position, and reducing the noise generated by the latch bolt 2 during its movement.

It can be understood that a diameter of the first hole is substantially equal to that of the first guide shaft 23.

Specifically, the first baffle 24 has a first end face and a second end face which are opposite to each other in an axial direction of the first guide shaft 23. The silent lock further includes a first washer, which is arranged on the first end face of the first baffle 24. A first end of the first spring 211 abuts against the latch bolt 2, and a second end of the first spring 211 abuts against the first end face of the first baffle 24 via the first washer.

Specifically, the silent lock further includes a second washer, which is arranged on the second end face of the first baffle 24. A first end of the second spring 221 abuts against the movable plate 25, and a second end of the second spring 221 abuts against the second end face of the first baffle 24 via the second washer.

In some embodiments, the silent lock further includes a detection tongue 3, a third elastic member 31 and a push sheet 32. The detection tongue 3 is slidably fitted inside the lock shell 1. The detection tongue 3 is movable between a second retracted position where it is located inside the lock shell 1 and a second extended position where it at least partially protrudes out of the lock shell 1. A direction in which the detection tongue 3 slides toward the second retracted position is consistent with a direction in which the latch bolt 2 slides toward the first retracted position. The third elastic member 31 is connected to the detection tongue 3 and the lock shell 1, and biases the detection tongue 3 toward the second extended position.

The push sheet 32 is located inside the lock shell 1 and is connected to the detection tongue 3. The latch bolt 2 has a limiting surface 26 facing the first baffle 24, and at least part of the push sheet 32 abuts against the limiting surface 26.

Therefore, when the latch bolt 2 is moved from the first extended position to the first retracted position by the external force, the detection tongue 3 is driven to move from the second extended position to the second retracted position through the cooperation between the limiting surface 26 and the push sheet 32. When the latch bolt 2 is reset, the detection tongue 3 resets under the action of the third elastic member 31, that is, returns to the second extended position. The detection tongue 3 is driven by the latch bolt 2 to move, thereby avoiding collision between the detection tongue 3 and the door frame when the door is opened, further reducing the noise, and ensuring the effect of silencing.

Specifically, the first extended position is aligned with the second extended position in a length direction of the lock shell 1, and the first retracted position is aligned with the second retracted position in the length direction of the lock shell 1.

In some embodiments, the silent lock further includes a second guide shaft 33 and a second baffle, and a first end of the second guide shaft 33 is connected to the detection tongue 3. The second baffle is fixedly arranged inside the lock shell 1 and is provided with a second hole, through which the second guide shaft 33 slides. The third elastic member 31 includes a third spring 311 arranged around the second guide shaft 33, and the third spring 311 is pressed between the second baffle and the detection tongue 3.

Therefore, the second guide shaft 33 restricts a sliding direction of the detection tongue 3 and ensures the sliding reliability of the detection tongue 3, and the third spring 311 is configured to provide an elastic force for the detection tongue 3 to assist the detection tongue 3 to reset.

It can be understood that a diameter of the second hole is substantially equal to that of the second guide shaft 33.

In some embodiments, the silent lock further includes a dead bolt assembly 4 and a first buffer member 41. The dead bolt assembly 4 is slidably connected to the lock shell 1, and is movable between a third retracted position where it is located inside the lock shell 1 and a third extended position where it at least partially protrudes out of the lock shell 1. The first buffer member 41 is fixedly arranged inside the lock shell 1, and the dead bolt assembly 4 abuts against the first buffer member 41 when it is in the third retracted position.

Therefore, the first buffer member 41 restricts the retraction stroke of the dead bolt assembly 4 and cushions the retraction movement of the dead bolt assembly 4, thereby avoiding the rigid collision of the dead bolt assembly 4, and further enhancing the effect of noise reduction and silencing.

In some embodiments, the dead bolt assembly 4 includes multiple dead bolts 42 and a connecting frame 43. The multiple dead bolts 42 are arranged and spaced apart from each other in the length direction of the lock shell 1, and each of the multiple dead bolts 42 is slidably connected to the lock shell 1. The connecting frame 43 is located inside the lock shell 1, with a first end of the connecting frame 43 being connected to each of the multiple dead bolts 42, and a second end of the connecting frame 43 abutting against the first buffer member 41 when the dead bolt assembly 4 is in the third retracted position.

Therefore, the connecting frame 43 is configured to drive the multiple dead bolts 42 to move synchronously. The design of the multiple dead bolts 42 further enhances the safety of the silent lock. The first buffer member 41 is configured to restrict the retraction of the connecting frame 43.

Specifically, the latch bolt 2, the detection tongue 3 and the multiple dead bolts 42 are arranged and spaced apart from each other in the length direction of the lock shell 1.

For the convenience of understanding, the length direction of the lock shell 1 is indicated by an arrow A in FIG. 1.

In some embodiments, the silent lock includes a second buffer member 44, which is disposed inside the lock shell 1 and is fixedly arranged between any two adjacent dead bolts 42. When the dead bolt assembly 4 is located in the third extended position, the second buffer member 44 is sandwiched between a peripheral wall of the lock shell 1 and the connecting frame 43.

Therefore, the first buffer member 41 restricts the extension stroke of the dead bolt assembly 4 and cushions the extension movement of the dead bolt assembly 4, thereby avoiding the rigid collision of the dead bolt assembly 4, and further enhancing the effect of noise reduction and silencing.

In some embodiments, the first buffer member 41 includes a support shaft 411 and a flexible sleeve 412. The support shaft 411 is fixedly arranged inside the lock shell 1, the flexible sleeve 412 is arranged around the support shaft 411, and the second end of the connecting frame 43 abuts against the flexible sleeve 412 when the dead bolt assembly 4 is in the third retracted position. The second buffer member 44 includes a flexible block 441.

Thus, the flexible sleeve 412 realizes a flexible cushioning for the retraction of the connecting frame 43, and the flexible block 441 realizes a flexible cushioning for the extension of the connecting frame 43.

Specifically, the flexible sleeve 412 may be made of a rubber, a silica gel, a sponge, or the like.

Specifically, the flexible block 441 may be made of a rubber, a silica gel, a sponge, or the like.

In some embodiments, the silent lock further includes a pin 5 and an anti-release hook 6. The latch bolt 2 has a mounting groove 27 and a first shaft hole 28. The first shaft hole 28 extends in the length direction of the lock shell 1 and is in communication with the mounting groove 27. The pin 5 passes through the first shaft hole 28 and the mounting groove 27 and is connected to the latch bolt 2. The anti-release hook 6 is provided with a second shaft hole 61. The anti-release hook 6 is arranged around the pin 5 by the second shaft hole 61 and is fitted in the mounting groove 27 in such a manner as to be pivoted relative to the pin 5.

Therefore, the anti-release hook 6 is rotatable to a suitable extent in the mounting groove 27 relative to the latch bolt 2, which ensures the protective effect of the anti-release hook 6 on the latch bolt 2, improves the safety of the latch bolt 2, and enhances the anti-theft performance of the latch bolt 2.

Specifically, the mounting groove 27 is provided in a middle part of the latch bolt 2.

Specifically, there are two first shaft holes 28, which are respectively arranged on two sides of the mounting groove 27.

In some embodiments, damping agent is filled between a wall surface of the second shaft hole 61 and an outer circumferential surface of the pin 5. Alternatively, damping coating is provided on an outer circumferential surface of the pin 5.

Therefore, the damping agent/damping coating reduces the rebound speed of the anti-release hook 6, and further enhances the effect of noise reduction and silencing.

In the description of the present application, it should be understood that the orientation or positional relationships indicated by terms such as “center”, “longitudinal”, “lateral”, “length”, “width”, “thickness”, “up”, “down”, “front”, “rear”, “left”, “right”, “vertical”, “horizontal”, “top”, “bottom”, “inner”, “outer”, “clockwise”, “anticlockwise”, “axial”, “radial”, and “circumferential” are based on the orientation or positional relationships shown in the accompanying drawings, and are merely for the convenience of description and the simplification of the description rather than indicating or implying that the referred device or element must be arranged in a particular orientation, or be constructed and operated in a particular orientation, and therefore should not be construed as limiting the present application.

In addition, the terms “first” and “second” are only used for description, and should not be understood as indicating or implying relative importance or implying the number of the indicated technical features. Therefore, a feature defined with “first” and “second” may explicitly or implicitly includes at least one of the features. In the description of the present application, the term “multiple/plurality of” means at least two, such as two, or three, unless clearly defined otherwise.

In the present application, unless clearly specified or defined otherwise, the terms such as “mounting”, “linkage”, “connection”, and “fixation” should be understood in a broad sense. For example, the “connection” may be a fixed connection, a detachable connection, or an integrated connection; may be a mechanical connection, an electrical connection, or connection in communication; may be a direct connection, an indirect connection via an intermediate medium, internal communication between two components, or interaction between two components, unless clearly defined otherwise. Those skilled in the art may understand meanings of the foregoing terms in the present application based on specific conditions.

In the present application, the description of a first feature being “above” or “below” a second feature may mean that the first feature is in direct contact with the second feature, or the first feature is in indirect contact with the second feature via an intermediate medium, unless clearly specified and defined otherwise. Moreover, the description of the first feature being “on”, “above” and “over” the second feature means that the first feature is directly above or obliquely above the second feature, or simply indicates that the first feature is higher than the second feature in height with reference to a horizontal line. The description of the first feature being “below”, “under” and “beneath” the second feature means that the first feature is directly below or obliquely below the second feature, or simply indicates that the first feature is lower than the second feature in height with reference to a horizontal line.

In the present application, terms such as “an embodiment”, “some embodiments”, “example”, “specific example”, or “some examples” means that a particular feature, structure, material or characteristic described in conjunction with the embodiment or example is included in at least one embodiment or example of the present application. In this specification, the schematic expressions of the above terms are unnecessarily directed to a same embodiment or example. Furthermore, the specific features, structures, materials or characteristics described may be combined in any one or more embodiments or examples in a suitable manner. In addition, those skilled in the art can combine and compose the different embodiments or examples and the features in the different embodiments or examples described in this specification without mutual contradiction.

Although the embodiments of the present application haven been shown and described above, it should be understood that the above embodiments are exemplary and cannot be understood as a limitation to the present application. Those skilled in the art can make changes, modifications, substitutions and variations to the above embodiments within the protection scope of the present application.

1. A silent lock, comprising:
a lock shell;
a latch bolt slidably connected to the lock shell, wherein the latch bolt is movable between a first retracted position where it is located inside the lock shell and a first extended position where it at least partially protrudes out of the lock shell; and
a first elastic member and a second elastic member, wherein the first elastic member is connected to the latch bolt and the lock shell and biases the latch bolt toward the first extended position, the second elastic member is connected to the latch bolt and the lock shell and biases the latch bolt toward the first retracted position, and when the latch bolt is located in the first extended position, an elastic force of the first elastic member is equal to that of the second elastic member.

2. The silent lock according to claim 1, further comprising:
a first guide shaft, wherein a first end of the first guide shaft is connected to the latch bolt;
a first baffle fixedly arranged inside the lock shell, wherein the first baffle is provided with a first hole, through which the first guide shaft slides, the first elastic member comprises a first spring arranged around the first guide shaft, and the first spring is pressed between the latch bolt and the first baffle; and
a movable plate, wherein the movable plate is located at a side of the first baffle facing away from the latch bolt and is connected to a second end of the first guide shaft, the second elastic member comprises a second spring arranged around the first guide shaft, and the second spring is pressed between the first baffle and the movable plate.

3. The silent lock according to claim 2, further comprising:
a detection tongue slidably fitted inside the lock shell, wherein the detection tongue is movable between a second retracted position where it is located inside the lock shell and a second extended position where it at least partially protrudes out of the lock shell, and a direction in which the detection tongue slides toward the second retracted position is consistent with a direction in which the latch bolt slides toward the first retracted position;
a third elastic member, wherein the third elastic member is connected to the detection tongue and the lock shell and biases the detection tongue toward the second extended position; and
a push sheet, wherein the push sheet is located inside the lock shell and is connected to the detection tongue, the latch bolt has a limiting surface facing the first baffle, and at least part of the push sheet abuts against the limiting surface.

4. The silent lock according to claim 3, further comprising:
a second guide shaft, wherein a first end of the second guide shaft is connected to the detection tongue; and
a second baffle fixedly arranged inside the lock shell, wherein the second baffle is provided with a second hole, through which the second guide shaft slides, the third elastic member comprises a third spring arranged around the second guide shaft, and the third spring is pressed between the second baffle and the detection tongue.

5. The silent lock according to claim 1, further comprising:
a dead bolt assembly slidably connected to the lock shell, wherein the dead bolt assembly is movable between a third retracted position where it is located inside the lock shell and a third extended position where it at least partially protrudes out of the lock shell; and
a first buffer member fixedly arranged inside the lock shell, wherein the dead bolt assembly abuts against the first buffer member when it is in the third retracted position.

6. The silent lock according to claim 5, wherein the dead bolt assembly comprises a plurality of dead bolts and a connecting frame,
the plurality of dead bolts are arranged and spaced apart from each other in a length direction of the lock shell, and each of the plurality of dead bolts is slidably connected to the lock shell; and
the connecting frame is located inside the lock shell, and has a first end connected to each of the plurality of dead bolts and has a second end abutting against the first buffer member when the dead bolt assembly is in the third retracted position.

7. The silent lock according to claim 6, comprising a second buffer member, wherein the second buffer member is disposed inside the lock shell and is fixedly arranged between any two adjacent dead bolts, and the second buffer member is sandwiched between a peripheral wall of the lock shell and the connecting frame when the dead bolt assembly is in the third extended position.

8. The silent lock according to claim 7, wherein the first buffer member comprises a support shaft and a flexible sleeve, the support shaft is fixedly arranged inside the lock shell, the flexible sleeve is arranged around the support shaft, and the second end of the connecting frame abuts against the flexible sleeve when the dead bolt assembly is in the third retracted position; and
the second buffer member comprises a flexible block.

9. The silent lock according to claim 1, further comprising:
a pin, wherein the latch bolt has a mounting groove and a first shaft hole, the first shaft hole extends in a length direction of the lock shell and is in communication with the mounting groove, and the pin is connected to the latch bolt by passing through the first shaft hole and the mounting groove; and
an anti-release hook having a second shaft hole, wherein the anti-release hook is arranged around the pin by inserting the pin through the second shaft hole and is fitted in the mounting groove in such a manner as to be pivoted relative to the pin.

10. The silent lock according to claim 9, wherein damping agent is filled between a wall surface of the second shaft hole and an outer circumferential surface of the pin, or damping coating is provided on an outer circumferential surface of the pin.
